(19) United States
(12) Patent Application Publication
(10) Pub. No.: US 2026/0355710 A1
(43) Pub. Date: Nov. 12, 2026

(54) AUTOMATED PLASMA EFFECT GENERATOR PYROLYSIS DEVICE

(71) Applicant: SHANXI XINXU BIOTECHNOLOGY CO., LTD., TAIYUAN (CN)

(72) Inventors: XUKUI YANG, TAIYUAN (CN); MINGXI GU, TAIYUAN (CN)

(21) Appl. No.: 19/433,295

(22) Filed: Dec. 26, 2025

(30) Foreign Application Priority Data
Mar. 5, 2025 (CN) 202510251552.8

(51) Int. Cl. B01J 6/00; B01J 4/00; B01J 19/08

(52) U.S. Cl. CPC B01J 6/008; B01J 4/001; B01J 19/087; B01J 2204/002; B01J 2219/0896

(57) ABSTRACT

An automated plasma effect generator pyrolysis device includes a vertically-provided support frame; a first crushing box provided thereon and having one side provided with a feed pipe; a first crushing assembly located on the first crushing box for material's primary crushing; a second crushing box on the support frame, at one side of the first crushing box; a second crushing assembly located on the second crushing box for material's secondary crushing; a screw conveyor; and a pyrolysis reactor at the bottom of the screw conveyor. A connecting pipe is provided on the first crushing box. The second crushing box communicates with the connecting pipe and has the bottom end provided with a material outlet pipe. The screw conveyor is located below the second crushing box and communicates with the material outlet pipe. The pyrolysis reactor communicates with the side of the screw conveyor away from the material outlet pipe.

### CROSS REFERENCE TO RELATED APPLICATIONS

The present disclosure claims the priority to the Chinese patent application with the filing No. 202510251552.8, entitled “AUTOMATED PLASMA EFFECT GENERATOR PYROLYSIS DEVICE” and filed on Mar. 5, 2025 with the Chinese Patent Office, the contents of which are incorporated herein by reference in their entirety.

### TECHNICAL FIELD

The present disclosure relates to the technical field of chemical equipment, and particularly to an automated plasma effect generator pyrolysis device.

### BACKGROUND ART

Pyrolysis equipment is equipment which can convert macromolecular substances of a sample into other small molecule substances. There are two types of small experimental pyrolysis reactors available on the market based on the heating, ultrasonic source type and high-frequency electromagnetic generator type. Both of the two energy sources are capable of crushing tissues, bacteria, viruses, spores and other cellular structures, as well as performing homogenization, emulsification, mixing, degassing, disintegration and dispersion, leaching and extraction, and accelerating reactions, and thus they are widely used in laboratory research and industrial production in biology, medicine, chemistry, pharmaceuticals, food, cosmetics, environmental protection and others.

For traditional plasma effect generator pyrolysis devices, the material is typically loaded into a pyrolysis reactor, the material is pyrolyzed by plasma effect generated inside the pyrolysis reactor, and the pyrolysis products are taken out from the pyrolysis reactor upon completion of the pyrolysis.

Traditional plasma effect generator pyrolysis devices require manual operation for feeding/loading, making continuous pyrolysis reaction unachievable.

### SUMMARY

In order to enable continuous pyrolysis, the present disclosure provides an automated plasma effect generator pyrolysis device.

The automated plasma effect generator pyrolysis device provided by the present disclosure adopts the following technical solutions.

An automated plasma effect generator pyrolysis device includes a support frame, a first crushing box, a first crushing assembly, a second crushing box, a second crushing assembly, a screw conveyor, and a pyrolysis reactor, where the support frame is vertically provided; and the first crushing box is provided on the support frame and has one side obliquely provided with a feed pipe, and a connecting pipe is provided on the side of the first crushing box away from the feed pipe; the first crushing assembly is located on the first crushing box and is used for performing primary crushing on the material; the second crushing box is located on one side of the first crushing box and is provided on the support frame, and the second crushing box communicates with the connecting pipe, and has a bottom end provided with a material outlet pipe; the second crushing assembly is located on the second crushing box and is used for performing secondary crushing on the primary-crushed material; the screw conveyor is located below the second crushing box and is provided on the support frame, and the screw conveyor communicates with the material outlet pipe; and the pyrolysis reactor is provided on the support frame and located at the bottom part of the screw conveyor, and the pyrolysis reactor communicates with one side of the screw conveyor away from the material outlet pipe.

By adopting the above technical solutions, in operation, the operator feeds the material into the first crushing box through the feed pipe, the first crushing assembly performs primary crushing on the material, the primary-crushed material enters the second crushing box through the connecting pipe, the second crushing assembly performs secondary crushing on the primary-crushed material, the secondary-crushed material falls into the screw conveyor through the feed pipe, the screw conveyor continuously transports the material to the inside of the pyrolysis reactor, and the material is by the plasma effect generated inside the pyrolysis reactor, enabling the pyrolysis reactor to pyrolyze the material continuously.

Optionally, the feed pipe is provided thereinside with a bearing plate, a first spring and a first touch switch, where the bearing plate is slidably provided inside the feed pipe, a sliding direction is perpendicular to an inclination direction of the feed pipe, the two ends of the first spring are fixedly connected to the feed pipe and the bearing plate, respectively, and the first touch switch is provided at the bottom part of the feed pipe and is used to control the operation of the first crushing assembly.

By adopting the above technical solutions, when the material is fed through the feed pipe, the material falls onto the bearing plate, the material presses the bearing plate, the bearing plate compresses the first spring to make the first spring in a compressed state, the bearing plate presses the first touch switch, the first touch switch controls the first crushing assembly to work, so that the first crushing assembly works after the material enters the first crushing box to realize the automatic control of the first crushing assembly.

Optionally, the first crushing assembly includes an electric push rod, a driving telescopic rod, and a gasbag, where the electric push rod is vertically provided on the top end of the first crushing box and electrically connected to the first touch switch, the movable end of the electric push rod is provided with a pressure plate, and the pressure plate is horizontally provided inside the first crushing box; the driving telescopic rod is horizontally provided on one side of the first crushing box near the feed pipe, and has a rod-less cavity filled with a liquid, the movable end of the driving telescopic rod is provided with a push plate, and the push plate is vertically provided inside the first crushing box; and the gasbag is located at the top part of the first crushing box, and is filled with a liquid inside, and the gasbag communicates with the rod-less cavity of the driving telescopic rod through a pipe.

By adopting the above technical solutions, the first touch switch controls the electric push rod to work after the material enters the first crushing box, the movable end of the electric push rod extends, and the movable end of the electric push rod drives the pressure plate to move downward, the pressure plate compresses the material, causing the material to be primary-crushed, and after the material is primary-crushed, the movable end of the electric push rod retracts, and the movable end of the electric push rod drives the pressure plate to move upward, the pressure plate compresses the gasbag, and the liquid in the gasbag flows through the pipe to the rod-less cavity of the driving telescopic rod, to make the volume of the rod-less cavity of the driving telescopic rod increase, and the movable end of the driving telescopic rod extends, the movable end of the driving telescopic rod drives the push plate to move in the direction away from the fixed end of the driving telescopic rod, and the push plate pushes the primary-crushed material into the second crushing box through the connecting pipe, thereby allowing the primary-crushed material to be automatically pushed into the second crushing box.

Optionally, a second touch switch is provided on one side of the first crushing box near the connecting pipe, and the second touch switch is used to control the operation of the second crushing assembly.

By adopting the above technical solutions, when the push plate pushes the primary-crushed material to the second crushing box through the connecting pipe, the push plate presses the second touch switch, and the second touch switch controls the second crushing assembly to work, so that the second crushing assembly works after the primary-crushed material enters the second crushing box, thus realizing the automatic control of the second crushing assembly.

Optionally, the second crushing assembly includes a motor, a rotating shaft, and crushing blades, where the motor is vertically provided at the top end of the second crushing box and electrically connected to the second touch switch; the rotating shaft is vertically provided inside the second crushing box and fixedly connected to the output shaft of the motor; and the crushing blades are horizontally provided and fixedly connected to the rotating shaft, and multiple crushing blades are provided circumferentially along the axis of the rotating shaft.

By adopting the above technical solutions, after the primary-crushed material enters the second crushing box, the second touch switch controls the motor to work, the output shaft of motor rotates to drive the rotating shaft to rotate, and the rotating shaft drives the crushing blades to rotate about the axis of the rotating shaft, and the crushing blades perform secondary crushing on the primary-crushed material, thereby preventing clogging when the material enters the screw conveyor.

Optionally, a filter screen plate is horizontally provided inside the second crushing box, and the filter screen plate is slidably connected to the second crushing box; a connecting plate is horizontally provided inside the second crushing box, the connecting plate is located below the filter screen plate, a second spring and a third touch switch are provided on the connecting plate, the two ends of the second spring are respectively fixedly connected to the filter screen plate and the connecting plate, the third touch switch is provided on the connecting plate, and the third touch switch is electrically connected to the screw conveyor.

By adopting the above technical solutions, after the primary-crushed material enters the second crushing box, the primary-crushed material falls onto the filter screen plate, smaller pieces of material pass through the filter screen plate, while larger pieces of material remain on the filter screen plate; the filter screen plate slides downward due to the influence of the gravity of the material on the filter screen plate, the filter screen plate compresses the second spring to make the second spring in a compressed state; and the filter screen plate presses the third touch switch, the third touch switch controls the screw conveyor to work, the screw conveyor transports the material screened by the filter screen plate into the pyrolysis reactor, and the crushing blades perform secondary crushing on the larger pieces of material, thereby preventing clogging when the material enters the screw conveyor.

Optionally, the top end of the pyrolysis reactor is provided with an exhaust pipe, and the exhaust pipe is provided with a pressure valve.

By adopting the above technical solutions, when the material is pyrolyzed by the plasma effect generated inside the pyrolysis reactor, the temperature inside the pyrolysis reactor rises continuously, causing the internal gas to expand upon heating; when the pressure valve detects that the pressure inside the pyrolysis reactor is relatively high, the pressure valve opens to allow the gas inside the pyrolysis reactor to be discharged through the exhaust pipe, thereby enabling the regulation of internal gas pressure via the exhaust pipe when the gas pressure inside the pyrolysis reactor increases.

Optionally, a waste gas treatment box is provided on one side of the pyrolysis reactor away from the second crushing box, where the waste gas treatment box is filled with a solid catalyst, the waste gas treatment box communicates with the exhaust pipe, and has one side away from the exhaust pipe provided with an outlet pipe.

By adopting the above technical solutions, when the gas inside the pyrolysis reactor is discharged through the exhaust pipe, the gas discharged by the pyrolysis reactor passes through the waste gas treatment box, the solid catalyst inside the waste gas treatment box filters the gas, making the harmful gases generated during the pyrolysis process filtered, and the filtered gases are discharged through a gas outlet pipe, thus making it not easy to cause environmental pollution during pyrolysis.

Optionally, the support frame is provided with a control panel, where the control panel is electrically connected to the electric push rod, the motor and the screw conveyor respectively, and the control panel controls the electric push rod, the motor and the screw conveyor to be shut down respectively.

By adopting the above technical solutions, when the operator stops feeding the material, the operator controls the electric push rod, motor and screw conveyor to be shut down in sequence through the control panel, thus facilitating the convenient shutdown and easy operation of the overall equipment.

In summary, the present disclosure includes at least one of the following beneficial technical effects.

By providing a first crushing assembly, a second crushing assembly, and a screw conveyor, the crushed material is easy to be continuously conveyed into the pyrolysis reactor by the screw conveyor, thereby enabling the pyrolysis reactor to continuously pyrolyze the material.

By providing an exhaust pipe and a waste gas treatment box, the harmful gases produced during the pyrolysis process in the pyrolysis reactor can be easily treated, making it not easy to cause environmental pollution.

### BRIEF DESCRIPTION OF DRAWINGS

FIG. 1 is a structural schematic view of an embodiment of the present disclosure;

FIG. 2 is a cross-sectional view of the embodiment of the present disclosure;

FIG. 3 is a partial enlarged view of part A in FIG. 2; and

FIG. 4 is a partial enlarged view of part B in FIG. 2.

Description of reference numerals in the figures:

1. support frame; 11. control panel;

2. first crushing box; 21. feed pipe; 211. bearing plate; 212. first spring; 213. first touch switch; 22. second touch switch; 23. connecting pipe;

3. first crushing assembly; 31. electric push rod; 311. pressure plate; 32. driving telescopic rod; 321. push plate; 33. gasbag;

4. second crushing box; 41. material outlet pipe; 42. connecting plate; 421. second spring; 422. third touch switch; 43. filter screen plate;

5. second crushing assembly; 51. motor; 52. rotating shaft; 53. crushing blade;

6. screw conveyor;

7. pyrolysis reactor; 71. material discharge pipe; 711. solenoid valve; 72. exhaust pipe; 721. pressure valve; and

8. waste gas treatment box; 81. gas outlet pipe.

### DETAILED DESCRIPTION OF EMBODIMENTS

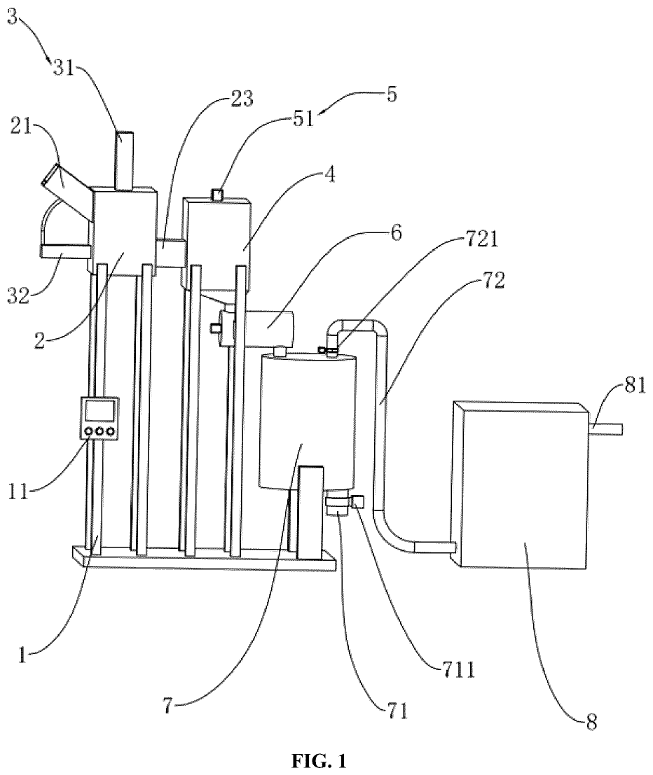

The present disclosure will be further described in detail below with reference to FIG. 1-4.

Embodiments of the present disclosure discloses an automated plasma effect generator pyrolysis device. Referring to FIG. 1, the automated plasma effect generator pyrolysis device includes a support frame 1, a first crushing box 2, a first crushing assembly 3, a second crushing box 4, a second crushing assembly 5, a screw conveyor 6, a pyrolysis reactor 7, and a waste gas treatment box 8. The support frame 1 is vertically provided, the first crushing box 2 is in the shape of a rectangular box, and vertically provided, and the first crushing box 2 is fixedly provided on the support frame 1. The first crushing assembly 3 is located on the first crushing box 2 and is used for performing primary crushing on the material. The second crushing box 4 is in the shape of a rectangular box, and vertically provided, the second crushing box 4 is located at one side of the first crushing box 2, and fixedly provided on the support frame 1, and the second crushing box 4 communicates with the first crushing box 2. The second crushing assembly 5 is located on the second crushing box 4 and is used for performing secondary crushing on the primary-crushed material. The screw conveyor 6 is horizontally provided and located below the second crushing box 4, the screw conveyor 6 is provided on the support frame 1, and communicates with the second crushing box 4. The pyrolysis reactor 7 is provided on the support frame 1 and located at the bottom part of the screw conveyor 6, the pyrolysis reactor 7 communicates with one side of the screw conveyor 6 away from the second crushing box 4. The waste gas treatment box 8 is in the shape of a rectangular box, and vertically provided, the waste gas treatment box 8 is filled with a solid catalyst, and the waste gas treatment box 8 communicates with the top end of the pyrolysis reactor 7.

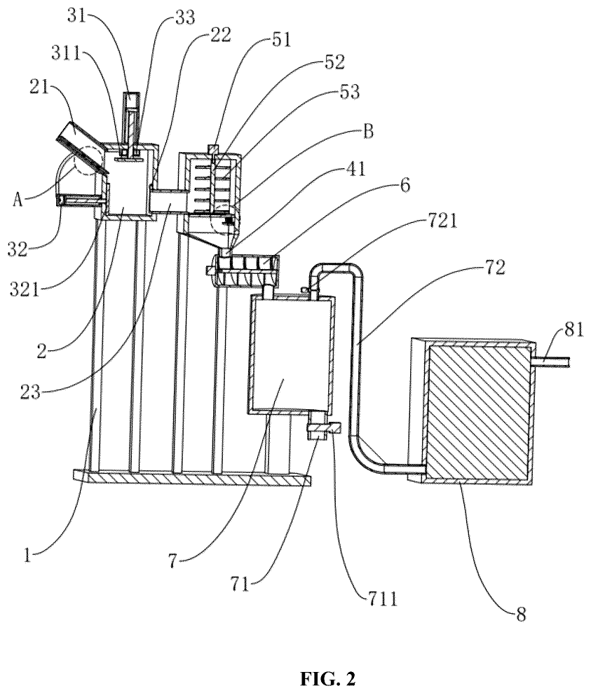

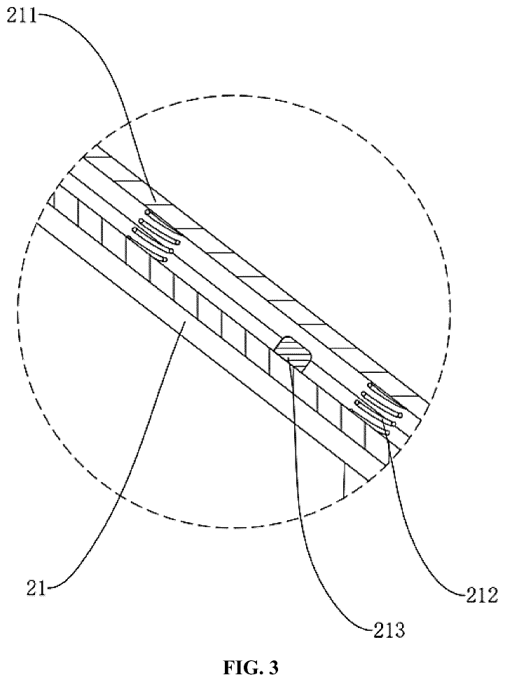

Referring to FIG. 1, FIG. 2, and FIG. 3, the support frame 1 is provided with a control panel 11, the control panel 11 is vertically provided and fixedly connected to the support frame 1, the control panel 11 is electrically connected to the screw conveyor 6 and is used to control the shutdown of the equipment. A feed pipe 21 communicates with one side of the first crushing box 2, the feed pipe 21 is in the shape of a rectangular tube and is provided obliquely downward from the side away from the first crushing box 2 to the side close to the first crushing box 2. A bearing plate 211, a first spring 212, and a first touch switch 213 are provided inside the feed pipe 21. The bearing plate 211 is in a shape of a rectangular plate and located at the bottom part of the feed pipe 21. The bearing plate 211 is slidably provided inside the feed pipe 21, and the sliding direction is perpendicular to an inclination direction of the feed pipe 21. The two ends of the first spring 212 are fixedly connected to the feed pipe 21 and the bearing plate 211, respectively. The first touch switch 213 is fixedly provided at the bottom part of the feed pipe 21. A second touch switch 22 is fixedly provided inside the first crushing box 2. The second touch switch 22 is located on the side of the first crushing box 2 away from the feed pipe 21. A connecting pipe 23 communicates with the side of the first crushing box 2 away from the feed pipe 21, the connecting pipe 23 is in a shape of a rectangular tube, and horizontally provided, and the side of the connecting pipe 23 away from the first crushing box 2 communicates with the second crushing box 4.

Referring to FIG. 1, FIG. 2 and FIG. 3, the first crushing assembly 3 includes an electric push rod 31, a driving telescopic rod 32, and a gasbag 33. The electric push rod 31 is vertically provided, and the fixed end is fixedly connected to the top end of the first crushing box 2. The electric push rod 31 is electrically connected to the first touch switch 213 and the control panel 11. The movable end of the electric push rod 31 is inserted into the first crushing box 2 and slides in the vertical direction of the first crushing box 2. A pressure plate 311 is fixedly provided on the movable end of the electric push rod 31. The pressure plate 311 is in a shape of a rectangular plate and horizontally provided. The driving telescopic rod 32 is horizontally provided, and has the fixed end fixedly connected to the side of the first crushing box 2 near the feed pipe 21. The movable end of the driving telescopic rod 32 is inserted into the first crushing box 2 and slidably connected in the width direction of the first crushing box 2. The rod-less cavity of the driving telescopic rod 32 is filled with a liquid. A push plate 321 is fixedly provided on the movable end of the driving telescopic rod 32. The push plate 321 is in a shape of a rectangular plate and vertically provided. The gasbag 33 is horizontally provided at the top part of the first crushing box 2 and is filled with a liquid inside. The gasbag 33 communicates with the rod-less cavity of the driving telescopic rod 32 through a pipe.

In operation, the operator feeds the material into the first crushing box 2 through the feed pipe 21. As the material is fed through the feed pipe 21, the material falls onto the bearing plate 211, the material presses the bearing plate 211, the bearing plate 211 compresses the first spring 212, putting the first spring 212 into a compressed state, the bearing plate 211 presses the first touch switch 213, the first touch switch 213 controls the electric push rod 31 to operate, the movable end of the electric push rod 31 extends, the movable end of the electric push rod 31 drives the pressure plate 311 to move downwards, and the pressure plate 311 compresses the material, resulting in primary crushing of the material. After primary crushing of the material, the movable end of the electric push rod 31 retracts, the movable end of the electric push rod 31 drives the pressure plate 311 to move upwards, the pressure plate 311 compresses the gasbag 33, the liquid inside the gasbag 33 flows through the pipe into the rod-less cavity of the driving telescopic rod 32, to make the volume of the rod-less cavity of the driving telescopic rod 32 increase, the movable end of the driving telescopic rod 32 extends, and the movable end of the driving telescopic rod 32 drives the push plate 321 to move in the direction away from the fixed end of the driving telescopic rod 32. The push plate 321 pushes the primary-crushed material into the second crushing box 4 through the connecting pipe 23, so that the primary-crushed material is automatically pushed into the second crushing box 4.

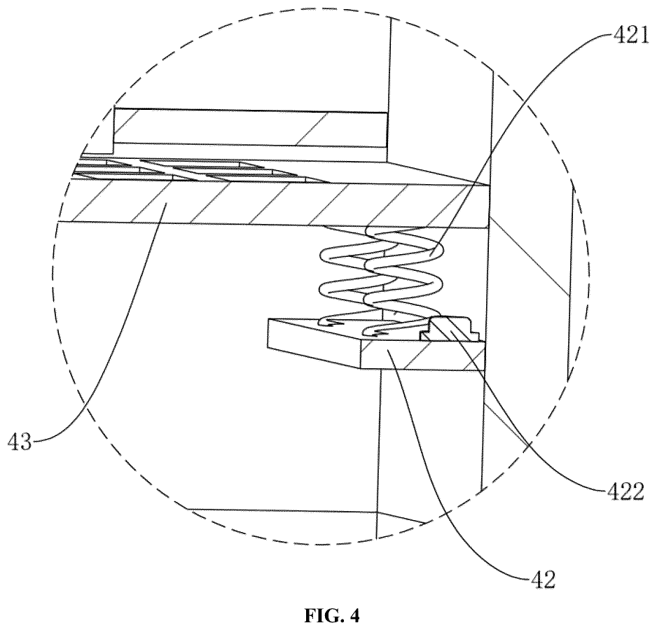

Referring to FIG. 2 and FIG. 4, the bottom end of the second crushing box 4 communicates with a material outlet pipe 41, the material outlet pipe 41 is in a shape of a circular tube and is vertically provided. The end of the material outlet pipe 41 away from the second crushing box 4 communicates with the screw conveyor 6. A connecting plate 42 and a filter screen plate 43 are provided inside the second crushing box 4. The connecting plate 42 is in a shape of a rectangular plate and is horizontally provided. The connecting plate 42 is fixedly provided on the side of the second crushing box 4 away from the first crushing box 2. A second spring 421 is vertically provided on the connecting plate 42. The bottom end of the second spring 421 is fixedly connected to the connecting plate 42. A third touch switch 422 is fixedly provided on the connecting plate 42, and the third touch switch 422 is electrically connected to the screw conveyor 6. The filter screen plate 43 is in a shape of a rectangular plate and is horizontally provided, the filter screen plate 43 is located above the connecting plate 42, the filter screen plate 43 is slidably connected to the second crushing box 4 in the height direction of the second crushing box 4, and the filter screen plate 43 is fixedly connected to the end of the second spring 421 away from the connecting plate 42.

Referring to FIG. 1 and FIG. 2, the second crushing assembly 5 includes a motor 51, a rotating shaft 52, and crushing blades 53. The motor 51 is vertically provided at the top end of the second crushing box 4 and is electrically connected to the second touch switch 22 and the control panel 11. The rotating shaft 52 is in a shape of circular rod, and is vertically provided inside the second crushing box 4, and the rotating shaft 52 is fixedly connected to the output shaft of the motor 51. The crushing blades 53 are in a shape of a rectangular plate, and are horizontally provided, the crushing blades 53 are fixedly connected to the rotating shaft 52, and multiple crushing blades 53 are provided circumferentially along the axis of the rotating shaft 52.

The push plate 321 pushes the primary-crushed material through the connecting pipe 23 to the second crushing box 4, the push plate 321 presses the second touch switch 22, the second touch switch 22 controls the motor 51 to work, the primary-crushed material falls onto the filter screen plate 43, smaller pieces of the material pass through the filter screen plate 43, while larger pieces of the material remain on the filter screen plate 43, the filter screen plate 43 slides downward due to the influence of the gravity of material on the filter screen plate 43, the filter screen plate 43 compresses the second spring 421, the second spring 421 is in a compressed state, the filter screen plate 43 presses the third touch switch 422, the third touch switch 422 controls the screw conveyor 6 to work, the screw conveyor 6 transports the material screened by the filter screen plate 43 into the pyrolysis reactor 7, the output shaft of the motor 51 rotates to drive the rotating shaft 52 to rotate, the rotating shaft 52 drives the crushing blades 53 to rotate about the axis of the rotating shaft 52, and the crushing blades 53 perform secondary crushing on the primary-crushed material, making it less likely to clog when the material enters the screw conveyor 6.

The bottom end of the pyrolysis reactor 7 communicates with a material discharge pipe 71, the material discharge pipe 71 is in a shape of a circular pipe and vertically provided, and a solenoid valve 711 is installed on the material discharge pipe 71. The top end of the pyrolysis reactor 7 communicates with an exhaust pipe 72, and the exhaust pipe 72 is in a shape of a circular pipe, and the end thereof away from the pyrolysis reactor 7 communicates with the waste gas treatment box 8, and a pressure valve 721 is mounted on the exhaust pipe 72. The end of the waste gas treatment box 8 away from the exhaust pipe 72 communicates with a gas outlet pipe 81, the gas outlet pipe 81 is in a shape of a circular tube, and is horizontally provided.

When the material is pyrolyzed by plasma effect generated inside the pyrolysis reactor 7, the temperature inside the pyrolysis reactor 7 rises continuously, causing the internal gas to expand upon heating, and when the pressure valve 721 detects that the pressure inside the pyrolysis reactor 7 is relatively high, the pressure valve 721 opens, allowing the gas inside the pyrolysis reactor 7 to be able to be discharged out through the exhaust pipe 72. The discharged gas passes through the waste gas treatment box 8, the solid catalyst inside the waste gas treatment box 8 filters the gas, thus filtering the harmful gases generated during the pyrolysis process, and the filtered gas is discharged through the gas outlet pipe 81, making it less likely to cause environmental pollution during pyrolysis.

The implementation principle of the automated plasma effect generator pyrolysis device according to the embodiments of the present disclosure is as follows.

In operation, the material is fed through the feed pipe 21, and the material falls onto the bearing plate 211, the material presses the bearing plate 211, the bearing plate 211 presses the first touch switch 213, the first touch switch 213 controls the electric push rod 31 to work, the movable end of the electric push rod 31 drives the pressure plate 311 to move downward, and the pressure plate 311 compresses the material, causing the material to be primary-crushed. After the material is primary-crushed, the movable end of the electric push rod 31 drives the pressure plate 311 to move upward, the pressure plate 311 compresses the gasbag 33, the liquid inside the gasbag 33 flows through the pipe into the rod-less cavity of the driving telescopic rod 32, the movable end of the driving telescopic rod 32 extends, the movable end of the driving telescopic rod 32 drives the push plate 321 to move in the direction away from the fixed end of the driving telescopic rod 32. The push plate 321 pushes the primary-crushed material into the second crushing box 4 through the connecting pipe 23, the material falls onto the filter screen plate 43, smaller pieces of the material pass through the filter screen plate 43, while larger pieces of the material remain on the filter screen plate 43.

The filter screen plate 43 is affected by the gravity of material, the filter screen plate 43 presses the third touch switch 422, the third touch switch 422 controls the screw conveyor 6 to work, the screw conveyor 6 transports the material screened by the filter screen plate 43 into the pyrolysis reactor 7, and when the push plate 321 approaches the connecting pipe 23, the movable end of the driving telescopic rod 32 drives the push plate 321 to press the second touch switch 22, the second touch switch 22 controls the motor 51 to work, the output shaft of the motor 51 rotates to drive the rotating shaft 52 to rotate, the rotating shaft 52 drives the crushing blades 53 to rotate about the axis of the rotating shaft 52. The crushing blades 53 perform secondary crushing on the primary-crushed material, making it less likely to clog when the material enters the screw conveyor 6. When the material is pyrolyzed by the plasma effect generated inside the pyrolysis reactor 7, the temperature inside the pyrolysis reactor 7 rises continuously, and when the pressure valve 721 detects that the pressure inside the pyrolysis reactor 7 is relatively high, the pressure valve 721 opens, allowing the gas inside the pyrolysis reactor 7 to be able to be discharged through the exhaust pipe 72, the discharged gas passes through the waste gas treatment box 8, the solid catalyst inside the waste gas treatment box 8 filters the gas, thus filtering the harmful gases generated during the pyrolysis process, and the filtered gas is discharged through the gas outlet pipe 81. When the operator stops feeding material, the operator controls the electric push rod 31, motor 51, and screw conveyor 6 to be shut down sequentially via the control panel 11, enabling the equipment to continuously pyrolyze the material. After the pyrolysis work is completed, the equipment may be shut down uniformly, making the overall equipment easy to operate.

The above are all preferred embodiments of the present disclosure, and are not intended to limit the scope of protection of the present disclosure accordingly. Therefore, all equivalent changes made in accordance with the structure, shape and principle of the present disclosure all should be covered within the scope of protection of the present disclosure.

1. An automated plasma effect generator pyrolysis device, comprising a support frame, a first crushing box, a first crushing assembly, a second crushing box, a second crushing assembly, a screw conveyor, and a pyrolysis reactor, wherein the support frame is vertically provided, the first crushing box is provided on the support frame and has one side obliquely provided with a feed pipe, and a connecting pipe is provided at one side of the first crushing box away from the feed pipe; the first crushing assembly is located on the first crushing box and configured for performing primary crushing on a material; the second crushing box is located at one side of the first crushing box, and provided on the support frame, and the second crushing box communicates with the connecting pipe and has a bottom end provided with a material outlet pipe; the second crushing assembly is located on the second crushing box and configured for performing secondary crushing on the primary-crushed material; the screw conveyor is located below the second crushing box and provided on the support frame, and the screw conveyor communicates with the material outlet pipe; the pyrolysis reactor is provided on the support frame and located at a bottom part of the screw conveyor, and the pyrolysis reactor communicates with one side of the screw conveyor away from the material outlet pipe; the first crushing assembly comprises an electric push rod, a driving telescopic rod and a gasbag, the electric push rod is vertically provided at a top end of the first crushing box, a movable end of the electric push rod is provided with a pressure plate, and the pressure plate is horizontally provided inside the first crushing box; the driving telescopic rod is horizontally provided at one side of the first crushing box near the feed pipe and has a rod-less cavity filled with a liquid, a movable end of the driving telescopic rod is provided with a push plate, and the push plate is vertically provided inside the first crushing box; and the gasbag is located at a top part of the first crushing box and filled with the liquid inside, and the gasbag communicates with the rod-less cavity of the driving telescopic rod through a pipe.

2. The automated plasma effect generator pyrolysis device according to claim 1, wherein a bearing plate, a first spring and a first touch switch are provided inside the feed pipe, the bearing plate is slidably provided inside the feed pipe, a sliding direction is perpendicular to an inclination direction of the feed pipe, two ends of the first spring are fixedly connected to the feed pipe and the bearing plate respectively, and the first touch switch is provided at a bottom part of the feed pipe and is configured for controlling the first crushing assembly to work.

3. The automated plasma effect generator pyrolysis device according to claim 2, wherein the electric push rod is electrically connected to the first touch switch.

4. The automated plasma effect generator pyrolysis device according to claim 3, wherein a second touch switch is provided at one side of the first crushing box near the connecting pipe, and the second touch switch is configured for controlling the second crushing assembly to work.

5. The automated plasma effect generator pyrolysis device according to claim 4, wherein the second crushing assembly comprises a motor, a rotating shaft and crushing blades, the motor is vertically provided at a top end of the second crushing box and electrically connected to the second touch switch; the rotating shaft is vertically provided inside the second crushing box and fixedly connected to the output shaft of the motor, the crushing blades are horizontally provided and fixedly connected to the rotating shaft, and multiple crushing blades are provided circumferentially along an axis of the rotating shaft.

6. The automated plasma effect generator pyrolysis device according to claim 5, wherein a filter screen plate is horizontally provided inside the second crushing box, and the filter screen plate is slidably connected to the second crushing box; a connecting plate is horizontally provided inside the second crushing box, the connecting plate is located below the filter screen plate, the connecting plate is provided with a second spring and a third touch switch, two ends of the second spring are fixedly connected to the filter screen plate and the connecting plate respectively, the third touch switch is provided on the connecting plate, and the third touch switch is electrically connected to the screw conveyor.

7. The automated plasma effect generator pyrolysis device according to claim 1, wherein an exhaust pipe is provided at a top end of the pyrolysis reactor, and the exhaust pipe is provided with a pressure valve.

8. The automated plasma effect generator pyrolysis device according to claim 7, wherein a waste gas treatment box is provided at one side of the pyrolysis reactor away from the second crushing box, the waste gas treatment box is filled with a solid catalyst, and the waste gas treatment box communicates with the exhaust pipe, and has one side away from the exhaust pipe provided with a gas outlet pipe.

9. The automated plasma effect generator pyrolysis device according to claim 5, wherein a control panel is provided on the support frame, the control panel is electrically connected to the electric push rod, the motor and the screw conveyor respectively, and the control panel is configured for controlling the electric push rod, the motor and the screw conveyor to be shut down respectively.
